(19) United States
(12) Patent Application Publication
(10) Pub. No.: US 2014/0009569 A1
(43) Pub. Date: Jan. 9, 2014

(54) Panogramic Camera System for Vehicle Event Data Recorder

(71) Applicant: Shih-Yao CHEN, New Taipei City (TW)

(72) Inventor: Shih-Yao CHEN, New Taipei City (TW)

(21) Appl. No.: 13/542,382

(22) Filed: Jul. 5, 2012

(51) Int. Cl. H04N 7/00

(52) U.S. Cl. 348/36; 348/E07.001

(57) ABSTRACT

A panoramic camera system used in a vehicle event data recorder in a car is disclosed to include front-facing and rear-facing camera lenses respectively installed in opposing front and rear sides of the and electrically connected to the vehicle event data recorder, and a side-facing camera lens mounted inside each of opposing left and right steering lamps of the car and electrically connected to the vehicle event data recorder.

### BACKGROUND OF THE INVENTION

1. Field of the Invention

The present invention relates to vehicle even data recording technology and more particularly, to a panoramic camera system for vehicle event data recorder, which has the characteristics of wear prevention and low maintenance cost.

2. Description of the Related Art

After years of technological evolution and by means of mass production, modern even data recorders are configured to have a more compact size and their cost has become more reasonable over the past years. An event data recorder is for use in a car to record information related to vehicle crashes or accidents. Information from the event data recorder can be collected after a crash and analyzed to help determine what the car was doing before, during and after the crash or event. An event data recorder for this purpose generally comprises a processor, multiple camera lenses for picking up images during steering of the car and providing obtained images to the processor for processing, and a data storage device for storing image data picked up by the camera lenses and processed by the processor, and a display screen for displaying images.

An event data recorder uses different camera lenses of different resolutions at different angles or sides. Subject to a continuous renovation-evolution-improvement pathway towards the goal of perfection, a modern event data recorder, for example, Digital Video Record (DVR), can record audio and video in a digital format to a data storage device, allowing video capture and playback to and from a hard disk for remote monitoring and control. However, using any type of photographing equipment in a car for recording image data must install multiple camera lenses at different locations of the car.

In order to enhance driving safety and to avoid image pickup dead angles, an event data recorder may use a panoramic camera system. A panoramic camera system includes front-facing camera lenses, rear-facing camera lenses and side-facing camera lenses respectively installed in the opposing front and rear sides and opposing left and right sides of a motor vehicle.

The side-facing camera lenses of a panoramic camera system are normally installed in the left and right outside rear-view mirrors of a motor vehicle. FIG. 1 illustrates the installation of a conventional panoramic camera system in a car. According to this design, the panoramic camera system comprises a front-facing camera lens 11 and a rear-facing camera lens 12 respectively mounted at the opposing front and rear sides of the car 10, and two side-facing camera lenses 13;14 respectively mounted at the left and right outside rear-view mirrors 15;16 of the car 10. Because the left and right outside rear-view mirrors 15;16 respectively protrude over the left and right sides of the car 10, they may be hit and damaged accidentally by an external object. Simply replacing a damaged outside rear-view mirror is less expensive. However, it is complicated and quite expensive to replace a damaged outside rear-view mirror with an attached side-facing camera lens.

### SUMMARY OF THE INVENTION

The present invention has been accomplished under the circumstances in view. It is main object of the present invention to provide a panoramic camera system for vehicle event data recorder, which has the characteristics of wear prevention and low maintenance cost.

It is another object of the present invention to provide a panoramic camera system for vehicle event data recorder, which has each side-facing camera lens be well protected in one respective steering lamp of the car carrying the vehicle event data recorder, avoiding impact damage.

It is another object of the present invention to provide a panoramic camera system for vehicle event data recorder, which facilitates replacement of each individual camera lens.

To achieve these and other objects of the present invention, a panoramic camera system is used in a vehicle event data recorder in a car, comprising front-facing and rear-facing camera lenses respectively installed in opposing front and rear sides of the and electrically connected to the vehicle event data recorder, and a side-facing camera lens mounted inside each of opposing left and right steering lamps of the car and electrically connected to the vehicle event data recorder.

Further, each side-facing camera lens is mounted inside the housing of the respective steering lamp of the car and protected by the glass lamp cover of the respective steering lamp.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing illustrating the mounting arrangement of a panoramic camera system of a vehicle event data recorder in a car according to the prior art.

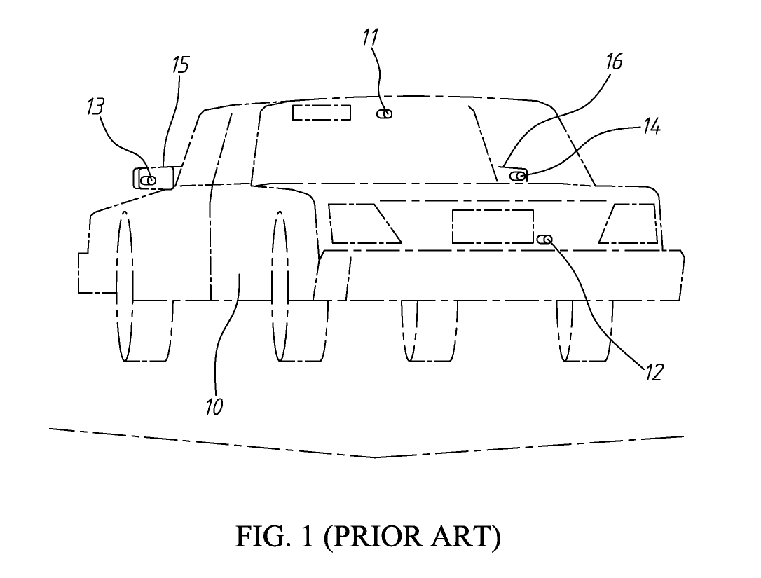

FIG. 2 is a schematic drawing illustrating the mounting arrangement of a panoramic camera system of a vehicle event data recorder in a car according to the present invention.

FIG. 3 is a schematic top view of FIG. 2.

### DETAILED DESCRIPTION OF THE PREFERRED EMBODIMENT

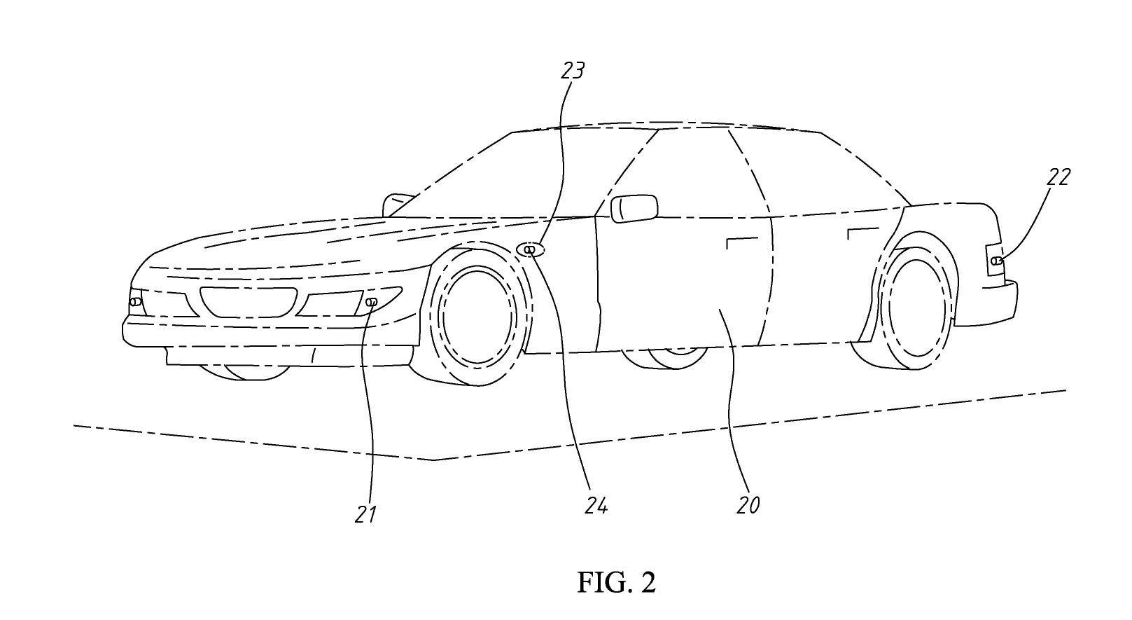

Referring to FIG. 2, a panoramic camera system for vehicle event data recorder in accordance with the present invention is shown installed in a car 20. The panoramic camera system for vehicle event data recorder comprises at least one front-facing camera lens 21 and at least one rear-facing camera lens 22 respectively installed in the opposing front and rear sides of the car 20, and a side-facing camera lens 24 mounted in the lamp housing of each steering lamp 24 of the car 20.

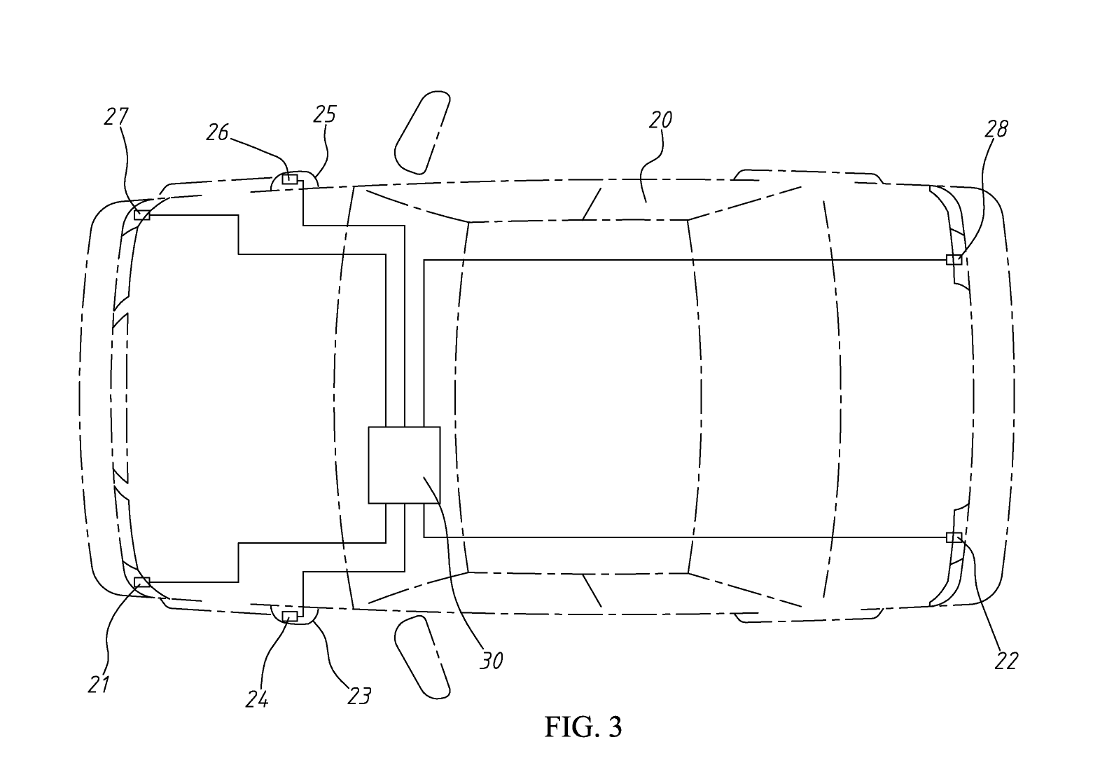

In one application example of the present invention, as shown in FIG. 3, the panoramic camera system for vehicle event data recorder comprises two front-facing camera lenses 21;27 and two rear-facing camera lenses 22;28 respectively bilaterally installed in the opposing front and rear sides of the car 20, and two side-facing camera lenses 24;26 respectively mounted in the lamp housing of each of the opposing left and right steering lamps 24;25 of the car 20. Further, the front-facing camera lenses 21;27, the rear-facing camera lenses 22;28 and the side-facing camera lenses 24;26 are respectively electrically connected to a vehicle event data recorder 30 inside the car 20.

The aforesaid example is simply for explanation of the spirit of the present invention but not intended for use as a limitation. For example, the panoramic camera system for vehicle event data recorder can be comprised of 4, 6 or 8 camera lenses.

Further, the side-facing camera lenses 24;26 are respectively mounted in the lamp housing of each of the left and right steering lamps 24;25 after removal of the respective glass lamp covers of the left and right steering lamps 24;25, and electrically connected to the original internal circuits of the left and right steering lamps 24;25.

Further, because the side-facing camera lenses 24;26 are respectively mounted inside the left and right steering lamps 24;25, they are well protected by the glass lamp covers of the left and right steering lamps 24;25 against impact, reducing maintenance costs.

Although a particular embodiment of the invention has been described in detail for purposes of illustration, various modifications and enhancements may be made without departing from the spirit and scope of the invention. Accordingly, the invention is not to be limited except as by the appended claims.

1. A panoramic camera system used in a vehicle event data recorder in a motor vehicle, comprising at least one front-facing camera lens and at least one rear-facing camera lens respectively installed in opposing front and rear sides of said motor vehicle and electrically connected to said vehicle event data recorder, and a side-facing camera lens mounted in each steering lamp of said motor vehicle and electrically connected to said vehicle event data recorder.

2. The panoramic camera system as claimed in claim 1, comprising two front-facing camera lenses and two rear-facing camera lenses respectively and bilaterally installed in opposing front and rear sides of said motor vehicle and electrically connected to said vehicle event data recorder, and two side-facing camera lenses respectively mounted inside opposing lest and right steering lamps of said motor vehicle and electrically connected to said vehicle event data recorder.

3. The panoramic camera system as claimed in claim 1, wherein each said side-facing camera lens is mounted inside a housing of one respective steering lamp of said motor vehicle and protected by a respective glass lamp cover.

4. The panoramic camera system as claimed in claim 2, wherein each said side-facing camera lens is mounted inside a housing of one respective steering lamp of said motor vehicle and protected by a respective glass lamp cover.
